(19) United States
(12) Patent Application Publication
(10) Pub. No.: US 2024/0150187 A1
(43) Pub. Date: May 9, 2024

(54) METHODS AND APPARATUS FOR PRODUCING AMMONIA IN A WELLBORE

(71) Applicant: Norce Innovation AS, STAVANGER (NO)

(72) Inventor: Eric Cayeux, STAVANGER (NO)

(73) Assignee: Norce Innovation AS, STAVANGER (NO)

(21) Appl. No.: 18/550,599

(22) PCT Filed: Mar. 30, 2022
(86) PCT No.: PCT/NO2022/050079

§ 371 Date: Sep. 14, 2023

(30) Foreign Application Priority Data
Mar. 31, 2021 (NO) 20210415

(51) Int. Cl. C01C 1/04; B01J 3/02; B01J 3/04; B01J 23/745; C25B 1/04; C25B 15/08; E21B 41/00

(52) U.S. Cl. CPC C01C 1/0417; B01J 3/02; B01J 3/04; B01J 23/745; C25B 1/04; C25B 15/081; E21B 41/0057

(57) ABSTRACT

Methods and apparatus are for producing ammonia. The method has steps of combining hydrogen gas and nitrogen gas in a wellbore to produce ammonia, and extracting the ammonia from the wellbore. The apparatus has at least one production device for combining hydrogen gas and nitrogen gas to produce ammonia, the production device being configured to be disposed downhole in a wellbore for utilising conditions of temperature and pressure in the wellbore to facilitate the production of the ammonia. A method of processing fluid in a process of producing hydrogen or ammonia is exemplified having steps of performing electrolysis of brine or other electrolyte fluid in the wellbore to produce hydrogen gas, and injecting waste fluid from the electrolysis process into a geological formation of the subsurface.

### CROSS-REFERENCE TO RELATED APPLICATIONS

This application is the U.S. national stage application of International Application PCT/NO2022/050079, filed Mar. 30, 2022, which international application was published on Oct. 6, 2022, as International Publication WO 2022/211643 in the English language. The International Application claims priority of Norwegian Patent Application Nos. 20210415, filed Mar. 31, 2021. The international application and Norwegian application are both incorporated herein by reference, in entirety.

### TECHNICAL FIELD

The present invention relates to alternative energy sources, and in particular to the production and supply of hydrogen and ammonia.

### BACKGROUND

Various industries today face the challenge of reducing environmental emissions. Suitable energy alternatives to fossil fuels are being sought, and amongst these are hydrogen and ammonia. Conventional industrial processes for producing ammonia generally result in high CO₂ emissions with hydrogen being obtained from natural hydrocarbon gas sources. The ammonia is produced in many industrial plants today using the Haber-Bosch chemical process where hydrogen and nitrogen are combined by chemical reaction.

An alternative that overcomes the drawback of the emissions associated with conventional hydrogen and ammonia production is green ammonia. Green ammonia is produced by hydrogen which again is produced by electrolysis of water. The European Union (EU) has set ambitious renewable energy targets for 2050 aiming for green ammonia and hydrogen to comprise approximately 24% of final energy demand. Furthermore, ammonia is the main fuel being considered by the maritime sector to allow the shipping industry to meet new CO₂ reduction targets proposed for 2030 and 2050. It may also be used as means to store renewable energy for later use, and as a carrier for hydrogen transportation. Indeed, green ammonia produced through a renewable and carbon-free process is seen by many as an energy carrier that may replace fossil fuels.

However, the processes and techniques for producing ammonia and hydrogen may themselves require energy to be supplied, for example the Haber-Bosch process in industrial plants is operated at elevated temperatures of up to 450 degrees Celsius and pressures of up to around 200 bar. The produced ammonia may then require further processing before being deliverable to users. The demands of such processes can be further exacerbated when tasked with supplying the product at industrial scale quantities. It is of interest to obtain more efficient production, storage and/or transport solutions for ammonia or hydrogen as fuel alternatives on industrial scale. At least one aim of the invention is to obviate or mitigate one or more drawbacks of prior art.

### SUMMARY

According to a first aspect of the invention there is provided a method of producing ammonia, the method comprising the steps of: combining hydrogen gas and nitrogen gas in a wellbore to produce the ammonia; and extracting the ammonia from the wellbore. The combining of the hydrogen gas and nitrogen gas may thus comprise utilising conditions of temperature and pressure in the wellbore to facilitate the production of the ammonia. This can be advantageous in the efficiency of production.

The hydrogen gas and the nitrogen gas may be combined by chemical reaction in at least one reaction chamber disposed in the wellbore. The ammonia may be produced by performing a Haber-Bosch process.

The method may preferably further include producing the hydrogen gas in the wellbore. The hydrogen gas may preferably be produced by performing electrolysis. Thus, green ammonia production using hydrogen from electrolysis may be provided for. The electrolysis may comprise electrolysis of formation brine or other electrolyte fluid in the wellbore. The electrolysis may be electrolysis of brine or another electrolyte fluid in the wellbore. The wellbore may extend into a geological formation of the subsurface, and the brine of fluid may be obtained in the wellbore through inflow of the brine from the formation. The brine may be received in the well by inflow from the geological formation surrounding a wellbore.

The method may further comprise providing at least one electrolysis device in the wellbore to perform the electrolysis. The method may include pumping waste fluid from the electrolysis away from the electrolysis device. The method may further comprise injecting the waste fluid into a geological formation of the subsurface.

The electrolysis may be performed in a first wellbore and the waste fluid may be pumped into a second wellbore which may be connected at depth to the first wellbore. The method may further comprise injecting the waste fluid into the geological formation through the second wellbore.

The ammonia may typically be extracted through wellbore tubing, e.g. production tubing, toward surface.

The method may further comprise providing a reaction chamber in the wellbore, in a downhole location of the wellbore. The method may thus include supplying the nitrogen gas to the reaction chamber from surface. The method may further comprises supplying the hydrogen gas produced in the wellbore to the reaction chamber to combine with the nitrogen gas.

The reaction chamber may typically be disposed in a tubing in the wellbore, e.g. near a downhole end of the wellbore.

In various embodiments, the method may comprise the steps of: performing electrolysis of brine or other electrolyte fluid in a wellbore to produce hydrogen gas, wherein the wellbore extends into a geological formation and the brine or electrolyte fluid is from the geological formation; combining hydrogen gas and nitrogen gas in the wellbore to produce ammonia, the hydrogen gas being from the electrolysis process; extracting the produced ammonia from the wellbore; and injecting waste fluid from the electrolysis process into a geological formation of the subsurface.

According to a second aspect of the invention, there is provided apparatus for producing ammonia, the apparatus comprising: at least one production device for combining hydrogen gas and nitrogen gas to produce ammonia, the production device being configured to be disposed downhole in a wellbore for utilising conditions of temperature and pressure in the wellbore to facilitate the production of the ammonia.

The apparatus may further comprise at least one electrolysis device which may be configured to be disposed downhole in the wellbore and may comprise electrodes for electrolysing brine or other electrolyte fluid from a formation of the wellbore.

The apparatus may further comprise at least one downhole pump for disposal in the wellbore. The downhole pump may be a submersible electric pump. The downhole pump may be configured for pumping waste fluid away from the electrolysis device in a first wellbore and into a second wellbore for injection into a formation of the subsurface. Indeed, the waste fluid can be processed downhole, and can thus be communicated from the first to the second wellbore without requiring it to be recovered to the surface. The second wellbore may be a branch of the first wellbore.

The one electrode of the electrolysis device may be an anode and the other electrode a cathode. The apparatus may further comprise an electrical power supply for surface supply of electrical power to the electrolysis device. The apparatus may further comprise at least one cable to be disposed in the wellbore for connecting the electrodes to the power source at the surface.

The electrical power supply may comprise at least one wind turbine. The ammonia may thus be generated renewably through power obtained from the wind turbine. The power supply may further be used to operate a heating element of a reaction chamber and/or the pump for pumping waste fluid from the electrolysis.

The production device may comprise at least one reaction chamber for combining the hydrogen gas and the nitrogen gas to produce the ammonia. The reaction chamber may be elongate to be arranged to extend longitudinally along the wellbore. The reaction chamber may be provided with a catalysis material, for example iron or any other suitable material. The apparatus may further comprise downhole tubing including the production device.

The apparatus may further comprise at least one heater element which may be configured to supply heat to the reaction chamber. Thus, heat from surroundings in the wellbore may be supplemented if required to obtain necessary conditions for producing the ammonia.

The apparatus may further comprise at least one cooling element which may be configured to cool the reaction chamber. Thus, the temperature in the reaction chamber may be lowered or controlled, e.g. to obtain necessary conditions for producing the ammonia.

The apparatus may further comprise tubing or a fluid line, e.g. a hydraulic line, to supply a cooling fluid to the cooling element to control the temperature of the reaction chamber. The cooling element may comprise tube sections arranged in heat exchange proximity to the reaction chamber. The tube sections of the cooling element may comprise or define coils or loops which may extend at least partially around the reaction chamber.

The reaction chamber may be configured to locally control the temperature by either heating using the heater element, or cooling by using the cooling element circulating a coolant fluid around the portion of the chamber to be locally temperature controlled.

The reaction chamber may be configured to direct the nitrogen gas to the chamber at multiple locations along the length of the reaction chamber. Thus, high degree of combining between nitrogen and hydrogen within the chamber may be made feasible.

The apparatus may include production tubing to be disposed in the wellbore for conveying produced ammonia toward surface. The production device may be a downhole production device.

In various embodiments, the apparatus may comprise: at least one production device for combining hydrogen gas and nitrogen gas to produce ammonia, the production device being configured to be disposed downhole in a wellbore for utilising conditions of temperature and pressure in the wellbore to facilitate the production of the ammonia; at least one electrolysis device configured to be disposed downhole in the wellbore and comprising electrodes for electrolysing brine or other electrolyte fluid from a formation of the wellbore; and means for injecting waste fluid from the electrolysis device into a formation of the subsurface.

According to a third aspect of the invention, there is provided production tubing configured to be disposed in a wellbore, the production tubing incorporating at least one reaction chamber for combining supplied nitrogen gas and hydrogen gas by chemical reaction in the wellbore to produce ammonia.

According to a fourth aspect of the invention, there is provided a method of processing fluid in a process of producing hydrogen or ammonia, the method comprising the steps of: performing electrolysis of brine or other electrolyte fluid in the wellbore to produce hydrogen gas; and injecting waste fluid from the electrolysis process into a geological formation of the subsurface.

The method may further comprise using the hydrogen gas to produce ammonia, or alternatively conveying the hydrogen gas along the wellbore toward surface.

According to a fifth aspect of the invention, there is provided apparatus for performing the method in accordance with the fourth aspect of the invention.

According to a sixth aspect of the invention, there is provided a method of producing hydrogen, the method comprising at least the step of performing electrolysis of brine or other electrolyte fluid from at least one subsurface rock formation so as to produce the hydrogen, the electrolysis being performed in wellbore extending through a region of said formation.

According to a seventh aspect of the invention, there is provided apparatus for performing the method in accordance with the sixth aspect of the invention.

According to a further aspect of the invention, there is provided a reaction chamber adapted to be disposed in a wellbore, the reaction chamber configured to combine supplied nitrogen gas and hydrogen gas by chemical reaction to produce ammonia. The reaction chamber may be or may have one or more further features as described in relation to any of the other aspects of the invention.

According to a yet further aspect of the invention, there is provided a production device for producing ammonia in a wellbore, the production device comprising at least one reaction chamber configured to combine supplied nitrogen gas and hydrogen gas by chemical reaction to produce ammonia. The production device may be or may have one or more further features as described in relation to any of the other aspects of the invention.

Embodiments of the invention may be advantageous in various ways as will be apparent from throughout the present specification.

The methods or apparatus of any of the above aspects may have one or more further features as described in relation to the methods or apparatus of any of the other aspects of the invention wherever described herein. In particular, the apparatus of any of the aspects of the invention may have any one or more further features as described in relation to the method of any of the aspects, and vice versa.

### BRIEF DESCRIPTION OF THE DRAWINGS

The various aspects of the invention will now be described further, by way of example only, with reference to the accompanying drawings, in which:

FIG. 1 is a schematic representation of apparatus for producing ammonia;

FIG. 2 is a schematic representation of apparatus for producing ammonia including additionally cooling means; and

FIG. 3 is a schematic representation of apparatus for processing fluid in a process of producing hydrogen.

### DETAILED DESCRIPTION OF THE DRAWINGS

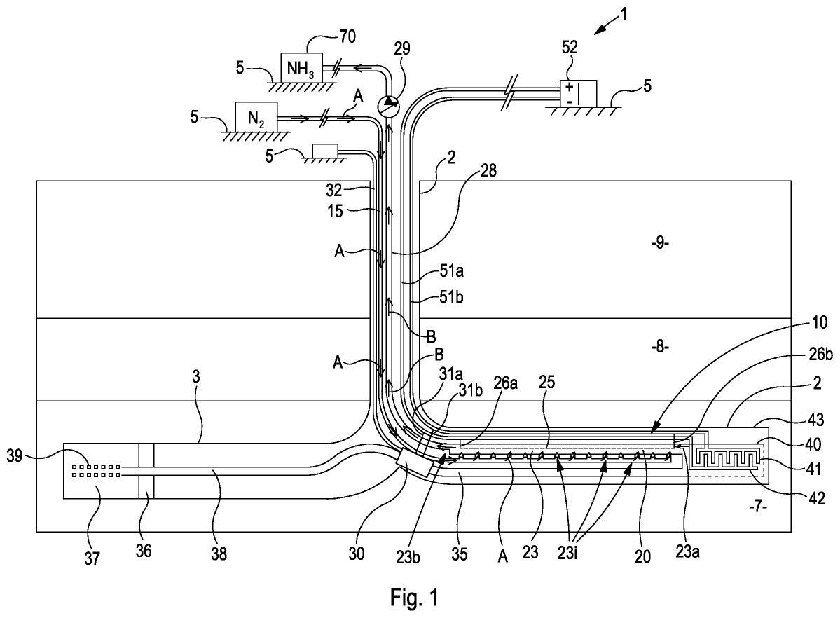

With reference to FIG. 1, apparatus 1 has downhole assembly 10 which is arranged downhole in a wellbore 2. The downhole assembly 10 is operable for combining hydrogen gas (H₂) and nitrogen gas (N₂) to produce ammonia (NH₃) in the wellbore. The ammonia is conveyed along the wellbore 2 through production tubing 28 toward the surface 5 and extracted from the wellbore 2.

The downhole assembly 10 includes a downhole production device 20 for producing ammonia. The downhole assembly 10 also includes, in this example, hydrogen production means in the form of an electrolysis device 40 for performing electrolysis downhole in the wellbore 2. The electrolysis of brine locally present in the downhole section of the wellbore is performed to produce hydrogen gas. The downhole production device 20 operates to combine the supplied hydrogen gas and nitrogen gas to produce ammonia in a reaction chamber 23 of the device 20. The production device 20 is supplied with hydrogen gas from the electrolysis device 40 and nitrogen gas from surface 5.

The apparatus 1 includes nitrogen supply tubing 15 extending in the wellbore 2 between the production device 20 and the surface 5 to communicate the nitrogen gas from the surface through the supply tubing 15 to the production device 20, as indicated by arrows A. The nitrogen is extractable from air using per se available techniques.

The production device 20 is disposed in a lateral section of the wellbore. The production device 20 extends longitudinally along the downhole tubing in the lateral section. Thus, the production device 20 can utilise the space in the wellbore lengthwise for producing the ammonia. Accordingly, the production device 20 has an elongate reaction chamber 23 extending along the tubing. The reaction chamber 23 of the production device 20 comprises a housing and is configured to provide controlled conditions in the reaction chamber 23, separated from its wellbore surroundings. The reaction chamber 23 is arranged to provide for contacting the hydrogen and the nitrogen and producing a chemical reaction between the two to form ammonia, in this example by way of the Haber-Bosch process. The Haber-Bosch process reaction is as follows:

N₂+3H₂↔2NH₃

In this process, the N₂ and H₂ gases are allowed to react at pressures typically in the range of 100 to 200 bar and at temperatures typically in the range of 400 to 450 degrees Celsius. The naturally occurring pressure, e.g. hydrostatically, in the wellbore of the reservoir section where the production device 20 is located is in that range of pressure. The process is also dependent upon temperature with elevated temperatures facilitating the reaction. The naturally occurring temperature in the wellbore, e.g. due to geothermal gradient, might in some cases be in the range mentioned above, but in the present example is somewhat lower, as is more typical for an old oil and gas well. However, temperatures are sufficiently elevated to obtain temperature conditions in the reaction chamber for reaction to occur, typically with only some limited addition of heat energy, as will be described further in the following. As will also be described, temperatures can also be reduced if required. Temperatures in the reaction chamber of 400 to 450 degrees Celsius are sought. Thus, the conditions in the downhole assembly 10 for production of ammonia are obtainable provided and allow the ammonia to be produced efficiently. The chamber 23 includes catalyst material, typically for example iron, to speed up the Haber-Bosch reaction.

The ammonia from the production device 20 is communicated from an exit of the chamber 23 along the wellbore 2 toward the surface through the production tubing 28, as indicated by arrows B. The ammonia is extracted from the wellbore 2 and conveyed to a recipient 70, the flow of ammonia from the tubing 28 passing through a choke 29.

To facilitate utilisation of space and conditions of the wellbore 2, the hydrogen gas from the electrolysis means 40 is directed into a reaction chamber 23 at a far end 23a of the production device 20. The hydrogen gas propagates toward a near end 23 of the production device 20 and is made available in the reaction chamber 23 at locations between the ends 23a, 23b. The nitrogen from supply tubing 15 is entered into the reaction chamber 23 at intermediate locations 23i distributed along the production device between the ends 23a, 23b. This configuration may facilitate implementation in the wellbore 2, may allow use of the wellbore conditions of temperature and pressure to facilitate the reaction of the hydrogen and nitrogen, and may allow the production of ammonia in significant quantities over the length of the production device 20.

As will be appreciated in some variants, the production device 20 has a longitudinal extent along the wellbore 2 that is greater or smaller than others, and it is not limited to use in horizontal sections. The production device 20 can thus be provided in sections of the wellbore that have vertical, deviated, and/or lateral trajectories. The production device 20 is in some examples provided in any downhole section of the wellbore, e.g. as part of the downhole tubing located in the wellbore 2, in any location where the conditions of pressure and temperature of the wellbore may facilitate the production of the ammonia in the ammonia reaction process, e.g. the Haber-Bosch process. Furthermore, it is to be noted that several production devices 20 are provided in the wellbore in some variants. Production devices 20 can also be provided in different branches of the wellbore 2. Similarly, one or more hydrogen producers 40 are used in some variants, to supply hydrogen to one or more production devices 20.

In addition, the production device 20 in FIG. 1 has a heating element 25 which extends along the reaction chamber 23. The heating element 25 comprises a resistance wire which when supplied with electrical current generates heat in the production device 20 and thus in the reaction chamber 23 to facilitate the chemical reaction for producing the ammonia. The heat from the heating element 25 can supplement that of the surroundings of the wellbore. The apparatus 1 includes cables 51a, 51b along an inside of the wellbore 2 for supplying electrical current into the well from a power supply 52 at the surface. The heating element 25 obtains electrical current which is supplied through the cables 51a, 51b from a power supply 52 at the surface 5. The heating element 25 is connected by wire sections 26a, 26b to the cables 51a, 51b. The supplied heat is controlled by controlling the supply of electrical current from the cables 51a, 51b. Thus, the desired temperature condition for facilitating the reaction of hydrogen and nitrogen to produce ammonia in the production device can be obtained. As the reaction is exothermic, once initiated, heat is produced which is utilized together with the heating element to raise temperatures further and to the extent required. Thus, heating element design may be adapted accordingly.

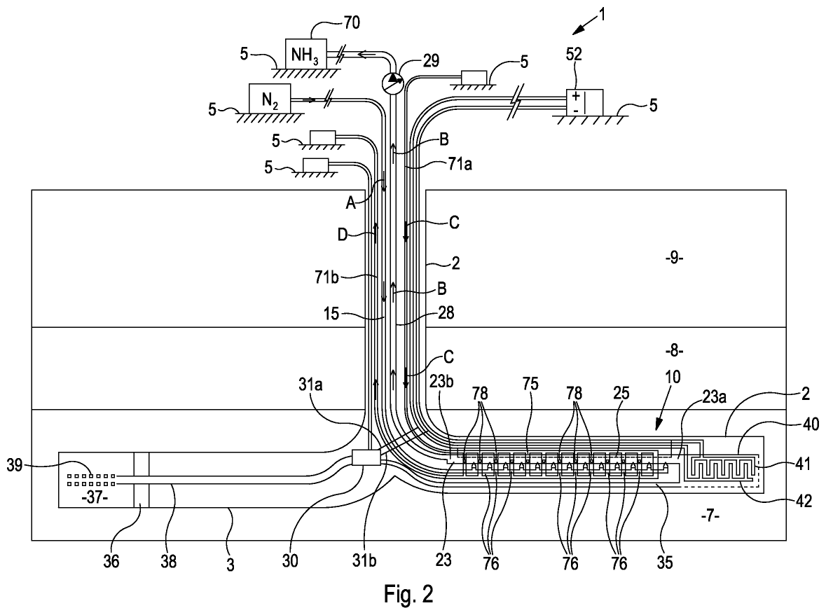

It is useful at this point to refer additionally to FIG. 2 which depicts a variant of the apparatus 1 further including cooling means. More specifically, the apparatus 1 of FIG. 2 has all features described in relation to FIG. 1 and in addition to these, the production device 20 of FIG. 2 has a cooling element 75 which extends along the reaction chamber 23. The cooling element 75 has tubular coils 76 that are arranged apart from one another along the reaction chamber 23 and loop around the reaction chamber 23. The cooling element 75 is in this way arranged in heat exchange relationship with the reaction chamber 23 so as to be operable to control the temperature conditions in and along the reaction chamber 23 for facilitating the reaction for producing the ammonia. A coolant fluid can be injected through line 71a which extends along the wellbore 2 between the downhole cooling element 75 and surface 5. The coolant fluid can flow through the line 71a as indicated by arrows C and pass through the coils 76 disposed along the reaction chamber 23 to reduce the local temperature of the reaction chamber 23 when necessary. Control valves 78 disposed at the entrance of each coil 76 can be used to control the flow of coolant fluid through each and therefore perform an active control of temperature in the reaction chamber 23. The coolant fluid is redirected to surface 75 through the line 71b as indicated by arrows D.

Continuing then with reference to FIG. 1 and/or FIG. 2, the electrolysis means 40 includes electrodes 41, 42 to perform electrolysis of the brine which is received in the wellbore as inflow from the formation into the wellbore 2 and into an electrolysis cell 43 of the electrolysis means 40. The electrodes 41, 42 are connected to the cables 51a, 51b to communicate electrical current from the power supply 52 at the surface through the downhole electrodes 41, 42. The electrode 41 is the cathode which is connected to the cable 51b and the negative terminal of the power supply 52. The electrode 42 is connected to the cable 51a and the positive terminal of the power supply 52. The electrodes acting as anode and cathode in contact with the brine in the electrolytic cell 43 act to electrolyse the brine. By way of the electrolysis, hydrogen gas is released from the brine and is directed out of the cell 43 and onward toward the reaction chamber 23 of the production device 20, e.g. through connecting hydrogen supply tubing or sealed conduit between the electrolysis device 40 and the production device 20. The electrolysis efficiency is facilitated by subjecting the hydrogen in the electrolysis to the pressure encountered in the well, e.g. 100 to 200 bar, and the in situ temperature.

The downhole assembly 10 is located in a section of the wellbore 2 that extends into a permeable geological reservoir formation 7. The wellbore 2 is an old wellbore previously constructed for purposes of oil and gas production and/or exploration. The section of the wellbore 2 is completed, e.g. with a gravel pack and sand screen or the like, as typically is done in the completed section of an oil or gas well for recovery of hydrocarbons. As the oil and gas reservoir over time is depleted of hydrocarbons, increasingly hydrocarbons may no longer be producible, and fluid that enters the wellbore through the screens from the reservoir formation may increasingly comprise brine. The brine accumulates in the reservoir formation 7 and enters the downhole section of the wellbore 2 in accordance with prevailing downhole and subsurface pressure conditions. As can be noted in FIG. 1, the reservoir formation 7 from which the brine is obtained is arranged beneath a cap rock 8, which is arranged in the subsurface below the overburden rocks 9. The reservoir formation 7 provides an extensive source of brine, and indeed the quantities of brine in the formation may be available in quantities greater than the original oil and gas reserves. Upon use of brine, further migration of fluids may be facilitated allowing replenishment of the reservoir with further brine over time. The availability of brine can therefore allow hydrogen to be produced, and in turn ammonia, in significant quantities. The provision of the downhole wellbore in the formation 7 provides advantageously electrolysis and production of ammonia close the source for the hydrogen production, which can reduce transport needs. This can be supported by the ammonia being produced in long ammonia production devices 20 extending in the wellbore to provide high ammonia production capacity. The wellbore in various examples is several kilometres long, as is typical for oil and gas wellbores. The wellbore can be provided with tubing extending into the wellbore in the reservoir formation of the wellbore from the surface, and the production device(s) 20 for producing the ammonia can correspondingly be provided to extend similarly within the wellbore, e.g. incorporated into downhole tubing or comprising a housing configured to be located in the wellbore and extending longitudinally within along the wellbore as far as desired and suitable.

With reference still to FIG. 1, the apparatus 1 also includes a downhole submersible pump 30. The pump 30 is arranged to pump waste fluid from the electrolysis process away from the electrolysis device 40. The waste fluid typically includes the liquid which remains after subjecting brine to the electrolysis process and hydrogen being removed. By drawing the waste fluid away, further inflow of formation brine into the electrolysis cell can be encouraged at the location of the electrolysis means. The brine is replenished in the cell 43, and the replenished brine includes hydrogen which can be produced as gas through operation of the electrolysis device 40 The pump 30 can also help to lower pressure in the wellbore section to facilitate drawing brine into the wellbore 2 from the formation 7.

The downhole submersible pump 30 pumps the waste fluid onward for injection into a subsurface geological formation where it is stored. The use of the pump to inject the waste into the formation can be useful because it can help to enhance the production of hydrogen at the electrolysis cell 43 by removing it to allow replenishment of fresh brine. Hydrogen production rates can thus be increased, and also the waste does not need to be brought to the surface and/or processed for example for removing contaminants. Thus, the solution of using the pump can reduce energy utilisation and make the process of producing the hydrogen gas and in turn the ammonia more efficient and less costly. Ammonia can in this manner be feasibly produced efficiently and in significant quantities to be used as a fuel by consumers.

In this example, more specifically, the waste fluid is injected into the formation 7 through a side wellbore 3. To this end, an injection tubing 38 is provided in a side wellbore 3 which branches off and extends laterally into the subsurface away from the wellbore 2. The submersible pump 30 is arranged to pump the waste fluid through the injection tubing 38 and into a formation of the side wellbore 3. A far end of the injection tubing 28 is provided with a packer 36 to seal an annulus of the side wellbore 3 around the injection tubing 38. The waste fluid exits through one or more outlets 39 of the injection tubing 38 in a sealed region 37 at a far side of the packer 36 and is injected into the surrounding formation. Operation of the pump 30 facilitates to draw the waste fluid away from the electrolysis device 40. The electrolysis device 40 is coupled to the submersible pump 30 through fluid tubing 35 for communicating the waste fluid to the pump 30.

The downhole submersible pump 30 is electrically operable by electrical current supplied through the cables 51a, 51b in the wellbore 2. The pump is connected to receive electrical power through connecting wires 31a, 31b to the cables 51a, 51b. A control line 32 is run from surface 2 to the downhole pump for providing data communication with the pump for controlling and/or operating the pump. Thus, the pump 30 may be controlled as required from surface.

In use, the power is supplied from the surface power source through the electrodes of the electrolysis device in the wellbore 2. Brine from the surrounding reservoir formation is received in the wellbore, and in the electrolysis cell 43 is electrolysed, such that hydrogen gas is produced and released from the electrolysis device and conveyed onward. The hydrogen gas is supplied to a reaction chamber 23 of the ammonia production device 20 in the wellbore. The nitrogen gas is supplied to the reaction chamber 23 from surface. In the reaction chamber 23, nitrogen and hydrogen are combined to form ammonia using the Haber-Bosch process. The temperature and pressure conditions prevailing at the wellbore depth, e.g. due to hydrostatic and geothermal gradient, are conducive and suitable for permitting an effective reaction of the nitrogen and hydrogen in the reaction chamber to produce ammonia. Heat is supplied to the extent required to the reaction chamber through an electrical heating element 25 which receives current through electrical power from surface. In the variant of FIG. 2, the reaction chamber 23 is also cooled through the cooling element, as and when required. Produced ammonia from the reaction chamber 23 is transported away from the production device 20 and conveyed to surface through production tubing 28 in the wellbore. Waste fluid from the electrolysis process, such as fluid that is no longer useful for electrolysis to produce hydrogen or otherwise not desired, is pumped by pump 30 away from the electrolysis device 40 and back to the formation where it is injected into the formation, e.g. through a side wellbore. The pump is controlled through communication line 32 from surface.

In some variants the electrical power supply 52 at surface comprises a renewable energy source. The renewable energy source in some examples comprises a wind turbine. In offshore wells the supply from an offshore wind turbine can be convenient and can contribute to the production of the ammonia in a more cost-efficient manner and fossil fuel free production of energy for the maritime sector.

The use of a long elongate reaction chamber 23 such as described in various examples above provides for large surfaces areas in the chamber and enhanced chances of collision, combining and/or reaction of molecules of hydrogen and nitrogen along the chamber 23. This can increase the efficiency in terms of the proportion, e.g. percentages, of hydrogen and nitrogen utilised to form ammonia. The molecules as they meander and propagate along the chamber can also spend a greater amount of time in contact with catalyst material in the chamber enhancing amount of ammonia produced through reaction of the molecules of nitrogen and hydrogen.

In some other examples, several reaction chambers 23 are provided in different locations along the tubing in wellbore instead of the one such as shown in FIG. 1. Hydrogen and nitrogen which has not combined to produce ammonia in one of the reaction chambers 23 is conveyed to a further one of the reaction chambers 23 where the reaction to ammonia then may take place. The provision of several chambers in series along the wellbore can therefore be used, exploiting the available length of the wellbore, and further increasing the efficiency of utilisation of the hydrogen and nitrogen, and increasing the amount of ammonia produced.

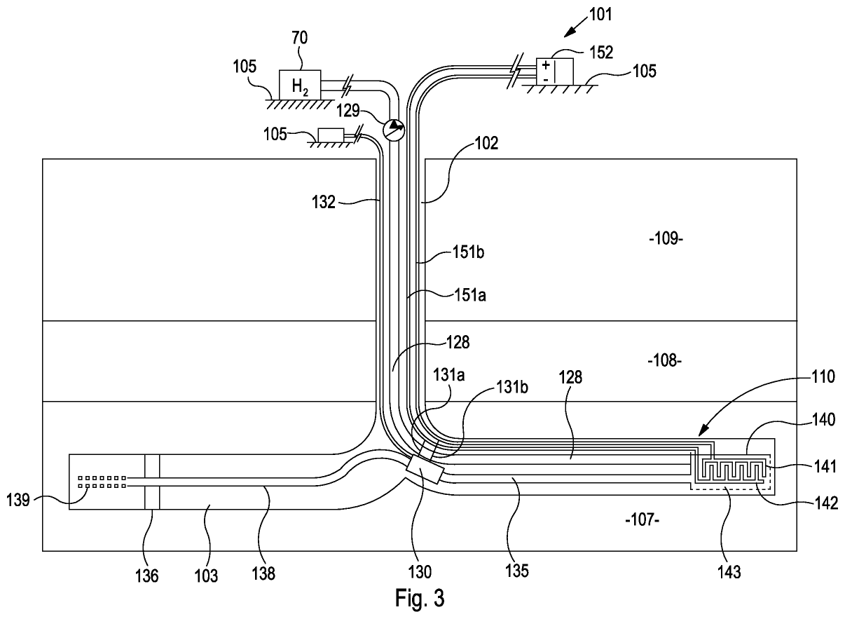

Turning then to FIG. 3, another apparatus 101 is depicted, where features corresponding to those of the apparatus 1 described above are denoted with the same reference numerals but incremented by one hundred. In the apparatus 101 of FIG. 3, the downhole assembly 110 includes the electrolysis device 140 for producing hydrogen gas through electrolysis of the brine. The production tubing 128 is provided in the wellbore 102 and extends between the surface 105 and the electrolysis device 140. The produced hydrogen gas is transported through the production tubing 128 and out of the wellbore 102. The submersible pump 130 operates to pump away waste fluid from the electrolysis device 140 into the side wellbore 103 where it is reinjected into the porous reservoir formation 7. By pumping away waste fluid, the brine in the electrolysis cell 143 can be replenished and hydrogen gas produced by the electrolysis at greater rates. The hydrogen gas from the wellbore 2 is received by a recipient 70 at the surface and utilised as required. The hydrogen gas can be used in fuel cells to produce electricity, or alternatively can be supplied to a facility to produce ammonia, e.g. onshore or elsewhere at the surface. In this variant of FIG. 2, as can be seen, the ammonia production device 20 to produce ammonia in the wellbore 2 is not used, and the tubing 15 for the supply of nitrogen is also not used.

The techniques above provide therefore for production of green ammonia in efficient manner and in large quantity through the electrolysis in the wellbore utilising the conditions of pressure and temperature in the wellbore. The formation brine from the porous formation as the source for electrolysis can provide practically an inexhaustible source of brine with water providing hydrogen and having a salt content suitable for electrolysis. By way of the production device in the wellbore the ammonia production can take place in the wellbore making use of the pressure conditions and the length of the wellbore to maximise production quantity with limited energy utilisation. Also, the pressure in the wellbore can facilitate the compression of the ammonia which is useful for storage and transport as ammonia is typically sought to be transported in compressed condition. Thus, transport and storage processes can be more efficient and/or costs can be reduced. Furthermore, waste products from the production process can be handled with low energy consumption.

The present technique can be considered an open-to-formation concept where the hydrogen needed for the reaction is produced in the wellbore open to the formation with water/brine in the wellbore. The apparatus can have one or more inlets open to the formation for supplying the water/brine into the electrolysis cell. The hydrogen from the electrolysis is directed to the reactor where it is combined with the nitrogen to produce ammonia. Waste from the electrolysis is directed back to the formation.

In various examples, a method of producing ammonia comprises performing electrolysis of brine or other electrolyte fluid in a wellbore to produce hydrogen gas, wherein the wellbore extends into a geological formation and the brine or electrolyte fluid is from the geological formation, combining hydrogen gas and nitrogen gas in the wellbore to produce ammonia, the hydrogen gas being from the electrolysis process, extracting the produced ammonia from the wellbore, and directing waste into a geological formation of the subsurface. The waste is typically waste fluid from the electrolysis process. The waste may be injected into the formation. The waste may be pumped away from the electrolysis cell.

In various examples, apparatus for producing ammonia comprises at least one production device for combining hydrogen gas and nitrogen gas to produce ammonia, the production device being configured to be disposed downhole in a wellbore for utilising conditions of temperature and pressure in the wellbore to facilitate the production of the ammonia, at least one electrolysis device configured to be disposed downhole in the wellbore and comprising electrodes for electrolysing brine or other electrolyte fluid from a formation of the wellbore, and means for directing waste into a formation of the subsurface, e.g. injecting waste fluid from the electrolysis process into the formation. The apparatus may include at least one pump for pumping the waste fluid away from the electrolysis cell.

Various modifications and improvements may be made without departing from the scope of the invention herein described. It will be apparent to the skilled person that processes other than Haber-Bosch could be utilised similarly for combining nitrogen and hydrogen to produce ammonia.

1. A method of producing ammonia, the method comprising the steps of:
performing electrolysis of brine or other electrolyte fluid in a wellbore to produce hydrogen gas, wherein the wellbore extends into a geological formation and the brine or electrolyte fluid is from the geological formation;
combining hydrogen gas and nitrogen gas in the wellbore to produce ammonia, the hydrogen gas being from the electrolysis process;
extracting the produced ammonia from the wellbore; and
injecting waste fluid from the electrolysis process into a geological formation of the subsurface.

2. The method as claimed in claim 1, wherein the hydrogen and the nitrogen are combined by chemical reaction in at least one reaction chamber disposed in the wellbore.

3. The method as claimed in claim 1, wherein the ammonia is produced by performing a Haber-Bosch process.

4. The method as claimed in claim 1, which further comprises utilising conditions of temperature and pressure in the wellbore to facilitate the production of the ammonia.

5. The method as claimed in claim 1, which further comprises: providing electrolysis device to perform the electrolysis; and pumping the waste fluid from the electrolysis away from the electrolysis device.

6. The method as claimed in claim 5, wherein the electrolysis is performed in a first wellbore and the waste fluid is pumped into a second wellbore which is connected at depth to the first wellbore, and the method further comprises injecting the waste fluid into the geological formation in the second wellbore.

7. The method as claimed in claim 1, wherein brine or electrolyte fluid is obtained in the wellbore through inflow of the brine from the formation.

8. The method as claimed in claim 1, wherein the ammonia is extracted through wellbore tubing toward surface.

9. The method as claimed in claim 1, which further comprises providing a reaction chamber in a downhole location of the wellbore, supplying nitrogen gas to the reaction chamber from surface.

10. The method as claimed in claim 9, which further comprises supplying hydrogen gas produced in the wellbore from the electrolysis process to the reaction chamber to combine with the nitrogen gas.

11. An apparatus for producing ammonia, the apparatus comprising:
at least one production device for combining hydrogen gas and nitrogen gas to produce ammonia, the production device being configured to be disposed downhole in a wellbore for utilising conditions of temperature and pressure in the wellbore to facilitate the production of the ammonia;
at least one electrolysis device configured to be disposed downhole in the wellbore and comprising electrodes for electrolysing brine or other electrolyte fluid from a formation of the wellbore;
means for injecting waste fluid from the electrolysis device into a formation of the subsurface.

12. The apparatus as claimed in claim 11, further comprising at least one downhole pump for disposal in the wellbore and configured for pumping waste fluid away from the electrolysis device in a first wellbore and into a second wellbore for injection into a formation of the subsurface.

13. The apparatus as claimed in claim 11, wherein the one electrode is an anode and the other electrode is cathode, and the apparatus further comprising an electrical power supply for surface supply of electrical power, and at least one cable to be disposed in the wellbore for connecting the electrodes to the power source at the surface.

14. The apparatus as claimed in claim 13, wherein the electrical power supply comprises at least one wind turbine.

15. The apparatus as claimed in claim 11, wherein the production device comprises at least one reaction chamber for combining the hydrogen gas and the nitrogen gas to produce the ammonia.

16. The apparatus as claimed in claim 15, wherein the reaction chamber is elongate to be arranged along the wellbore.

17. The apparatus as claimed in claim 15, wherein the reaction chamber is provided with a catalysis material.

18. The apparatus as claimed in claim 15, further comprising downhole tubing including the production device.

19. The apparatus as claimed in claim 15, further comprising a heater element which is configured to supply heat to the reaction chamber.

20. The apparatus as claimed in claim 15, further comprising a cooling element which is configured to cool the reaction chamber.

21. The apparatus as claimed in claim 15, wherein the reaction chamber is configured to direct nitrogen to the chamber at multiple locations along the length of the reaction chamber.

22. The apparatus as claimed in claim 15, further comprising production tubing to be disposed in the wellbore for conveying produced ammonia toward surface.

23. A production tubing configured to be disposed in a wellbore, the production tubing incorporating at least one reaction chamber for combining supplied nitrogen gas and hydrogen gas by chemical reaction in the wellbore to produce ammonia.
